(19) United States
(12) Patent Application Publication
(10) Pub. No.: US 2024/0408550 A1
(43) Pub. Date: Dec. 12, 2024

(54) AMORPHOUS FLUOROPOLYMER MEMBRANES

(71) Applicant: Pall Corporation, Port Washington, NY (US)

(72) Inventor: Steven GARDNER, Pensacola, FL (US)

(21) Appl. No.: 18/208,521

(22) Filed: Jun. 12, 2023

(51) Int. Cl. B01D 67/00; B01D 69/02; B01D 71/36

(52) U.S. Cl. CPC B01D 67/0013; B01D 69/02; B01D 71/36; B01D 2325/02833; B01D 2325/04

(57) ABSTRACT

A porous membrane is provided comprising a layer (A), a layer (B), and a layer (C) with an orientation of A-C-B, wherein layer (A) comprises an amorphous fluoropolymer, layer (B) comprises a symmetric fluoropolymer membrane or an asymmetric fluoropolymer membrane, and layer (C) comprises a composite fluoropolymer comprising (i) the amorphous fluoropolymer and (ii) the symmetric fluoropolymer membrane or the asymmetric fluoropolymer membrane. Methods of making and of using the porous membrane are also provided.

### BACKGROUND OF THE INVENTION

Traditional methods for producing PTFE membranes, e.g., by extruding, heating, stretching, and/or calendaring, can be energy-intensive, and are unsuitable for achieving a membrane with the desired pore size, chemical stability, nitrogen flux, and cleanliness. Thus, there is a continued need to develop finer, faster, and cleaner PTFE membranes (e.g., expanded PTFE membranes), particularly for filtration in microelectronics applications.

These and other advantages of the present invention will be apparent from the description as set forth below.

### BRIEF SUMMARY OF THE INVENTION

The invention provides a porous membrane comprising a layer (A), a layer (B), and a layer (C) with an orientation of A-C-B, wherein
layer (A) comprises an amorphous fluoropolymer,
layer (B) comprises a symmetric fluoropolymer membrane or an asymmetric fluoropolymer membrane, and
layer (C) comprises a composite fluoropolymer comprising (i) the amorphous fluoropolymer and (ii) the symmetric fluoropolymer membrane or the asymmetric fluoropolymer membrane.

The invention also provides a porous membrane comprising a layer (A), a layer (B), and a layer (C) with an orientation of B-C-A-C-B, wherein
each layer (A) comprises an amorphous fluoropolymer,
each layer (B) comprises a symmetric fluoropolymer membrane or an asymmetric fluoropolymer membrane, and
each layer (C) comprises a composite fluoropolymer comprising (i) the amorphous fluoropolymer and (ii) the symmetric fluoropolymer membrane or the asymmetric fluoropolymer membrane.

The invention also provides a method of making a porous membrane, the method comprising:
(i) casting a solution comprising an amorphous fluoropolymer resin on a first surface of a symmetric fluoropolymer membrane or an asymmetric fluoropolymer membrane,
(ii) applying a pressure to a second surface of the symmetric fluoropolymer membrane or the asymmetric fluoropolymer membrane, thereby drawing at least a portion of the solution comprising the amorphous fluoropolymer into the symmetric fluoropolymer membrane or the asymmetric fluoropolymer membrane, and
(iii) phase inverting the solution comprising the amorphous fluoropolymer resin to form a porous membrane comprising a layer (A), a layer (B), and a layer (C) with an orientation of A-C-B, wherein
   a. layer (A) comprises an amorphous fluoropolymer,
   b. layer (B) comprises a symmetric fluoropolymer membrane or an asymmetric fluoropolymer membrane, and
   c. layer (C) comprises a composite fluoropolymer comprising (i) the amorphous fluoropolymer and (ii) the symmetric fluoropolymer membrane or the asymmetric fluoropolymer membrane.

The invention also provides a method of making a porous membrane, the method comprising:
(i) casting a solution comprising an amorphous fluoropolymer resin on a first surface of a first symmetric fluoropolymer membrane or a first asymmetric fluoropolymer membrane,
(ii) applying a first surface of a second symmetric fluoropolymer membrane or a second asymmetric fluoropolymer membrane onto the cast solution,
(iii) applying a pressure to a second surface of the first symmetric fluoropolymer membrane or the first asymmetric fluoropolymer membrane and/or a second surface of the second symmetric fluoropolymer membrane or the second asymmetric fluoropolymer membrane, thereby drawing at least a portion of the solution comprising the amorphous fluoropolymer into the first symmetric fluoropolymer membrane or the first asymmetric fluoropolymer membrane and/or the second symmetric fluoropolymer membrane or the second asymmetric fluoropolymer membrane, and
(iv) phase inverting the solution comprising the amorphous fluoropolymer resin to form a porous membrane comprising a layer (A), a layer (B), and a layer (C) with an orientation of B-C-A-C-B, wherein
   a. layer (A) comprises an amorphous fluoropolymer,
   b. layer (B) comprises a symmetric fluoropolymer membrane or an asymmetric fluoropolymer membrane, and
   c. layer (C) comprises a composite fluoropolymer comprising (i) the amorphous fluoropolymer and (ii) the symmetric fluoropolymer membrane or the asymmetric fluoropolymer membrane.

The invention further provides a method of treating a contaminated fluid comprising passing at least a portion of the contaminated fluid through a porous membrane described herein and a method of recovering a material from a fluid comprising passing at least a portion of the fluid through a porous membrane described herein, so as to retain at least a portion of the material on the porous membrane.

### BRIEF DESCRIPTION OF THE DRAWINGS

FIG. 1 is a drawing providing a schematic showing an exemplary method for preparing a porous membrane, described herein, by applying pressure via a vacuum.

FIG. 2 is a scanning electron microscope (SEM) image of the porous membrane prepared in Example 1, with a view field of 12 μm.

FIGS. 3A-3D are four separate scanning electron microscope (SEM) images of the porous membrane prepared in Example 1, with a view field of 55.5 μm, where (A) designates the amorphous fluoropolymer layer, (C) designates the composite layer, and (B) designates the asymmetric fluoropolymer membrane layer in each of FIGS. 3A, 3B, 3C, and 3D.

FIG. 4 is a graph showing the mean flow pore (MFP) size and the N₂ flux @ 100 psi (lpm/cm²) of the porous membrane prepared in Example 1.

FIG. 5 provides a schematic showing an exemplary method for preparing a porous membrane, described herein, by applying pressure via a Mayer bar.

FIG. 6 is a scanning electron microscope (SEM) image of the porous membrane prepared in Example 2, with a view field of 277 μm.

FIGS. 7A-7D are scanning electron microscope (SEM) images of the porous membrane prepared in Example 2, with view fields of 111 μm (FIG. 7A), 55.5 μm (FIG. 7B), 27.7 μm (FIG. 7C), and 13.9 μm (FIG. 7D), where (A) designates the amorphous fluoropolymer layer, (C) designates the composite layer, and (B) designates the asymmetric fluoropolymer membrane layer.

FIG. 8 is a graph showing the mean flow pore (MFP) size and the N₂ flux @ 100 psi (lpm/cm²) of the porous membrane prepared in Example 2.

FIG. 9 is a graph showing the mean flow pore (MFP) size and the N₂ flux @ 100 psi (lpm/cm²) of the porous membrane prepared in Example 3.

### DETAILED DESCRIPTION OF THE INVENTION

The invention provides a porous membrane comprising a layer (A), a layer (B), and a
layer (C) with an orientation of A-C-B, wherein
layer (A) comprises an amorphous fluoropolymer,
layer (B) comprises a symmetric fluoropolymer membrane or an asymmetric fluoropolymer membrane, and
layer (C) comprises a composite fluoropolymer comprising (i) the amorphous fluoropolymer and (ii) the symmetric fluoropolymer membrane or the asymmetric fluoropolymer membrane.

In some embodiments, the invention provides a porous membrane comprising a layer (A), a layer (B), and a layer (C) with an orientation of B-C-A-C-B, wherein
each layer (A) comprises an amorphous fluoropolymer,
each layer (B) comprises a symmetric fluoropolymer membrane or an asymmetric fluoropolymer membrane, and
each layer (C) comprises a composite fluoropolymer comprising (i) the amorphous fluoropolymer and (ii) the symmetric fluoropolymer membrane or the asymmetric fluoropolymer membrane.

The porous membrane comprises layer (A) comprising an amorphous fluoropolymer. As used herein, the term “amorphous fluoropolymer” refers to a fluorinated (e.g., perfluorinated) polymer lacking crystallinity. The amorphous fluoropolymer can be any suitable fluorinated (e.g., perfluorinated) polymer lacking crystallinity. For example, the amorphous fluoropolymer can be a homopolymer or, preferably, a copolymer comprising 2 or more monomers (e.g., 3 monomers, 4 monomers, 5 monomers, or more).

Examples of suitable amorphous fluoropolymer monomers include fluorinated olefin monomers such as tetrafluoroethylene (“TFE”), vinylidene fluoride, and hexafluoropropylene, and fluorinated functional monomers such as perfluoroalkylvinyl ethers, perfluoroesters, perfluorosulfonylfluorides, and perfluorodioxoles. In some embodiments, the amorphous fluoropolymer comprises an ether group, a dioxole group, or a combination thereof. In certain embodiments, the amorphous fluoropolymer comprises at least one tetrafluoroethylene unit and at least one fluorinated ether unit, fluorinated dioxole unit, or a combination thereof. A preferred amorphous fluoropolymer is a copolymer of tetrafluoroethylene and a perfluorodioxole. Exemplary perfluorodioxoles include perfluoro-1,3-dioxole and perfluoro-2,2-dimethyl-1,3-dioxole (“PDD”). Thus, in other embodiments, the amorphous fluoropolymer is a copolymer of PDD with one or more comonomers selected from TFE, vinylidene fluoride, and hexafluoropropylene. A particular example of an amorphous fluoropolymer suitable for preparing the porous membrane of the present invention is a copolymer of PDD and TFE.

In some embodiments, layer (A) comprising an amorphous fluoropolymer is prepared from an amorphous fluoropolymer resin selected from a CHEMOURS™ Teflon AF resin (e.g., CHEMOURS™ TEFLON™ AF1600 or CHEMOURSIM TEFLON™ AF2400), an Asahi Glass Company CYTOP™ resin, a Solvay HYFLON™ resin, or a combination thereof.

The layer (A) comprising an amorphous fluoropolymer may be cast from a casting solution comprising an amorphous fluoropolymer described herein and one or more solvents and/or non-solvents. Exemplary solvents/non-solvents include, but are not limited to, halogenated solvents such as fluorocarbons (e.g., perfluorocarbons) or solvents from the 3M™ NOVEC™ series (e.g., 3M™ NOVEC™ 7500), GENESOL V™ 2000 (1,1-dichloro-1-fluoroethane) from AlliedSignal, Inc., FC-43 (perfluoro C₁₂ alkane) from 3M™ ECTFE™ oil (ethylene-chlorotrifluoroethylene copolymer) from Halocarbon Co. (River Edge, N.J.), CHEMOURS™ OPTEON™ series, SOLVAY™ SOLKANE™ series, acetone, ethanol, isopropanol, diethyl ether, ethyl acetate, tetrahydrofuran, and a combination thereof.

The porous membrane comprises layer (B) comprising a symmetric fluoropolymer membrane or an asymmetric fluoropolymer membrane, i.e., a symmetric (e.g., isotropic) fluoropolymer and asymmetric (e.g., anisotropic) fluoropolymer porous (e.g., microporous) membrane. As used herein, the term “symmetric fluoropolymer membrane” refers to a fluoropolymer membrane having a pore structure (e.g., a mean pore size) that is substantially the same throughout the membrane, i.e., from one surface to the other. As used herein, the term “asymmetric fluoropolymer membrane” refers to a fluoropolymer membrane having a pore structure (e.g., a mean pore size) that varies throughout the membrane, typically, (i) increasing in size from one surface of the membrane to the other surface or (ii) having an hourglass shape where the pore size is decreased at a position within the thickness of the membrane and increased at the opposing surfaces.

In some embodiments, the symmetric fluoropolymer membrane or the asymmetric polymer membrane comprises polytetrafluoroethylene (PTFE). In some embodiments, the polytetrafluoroethylene (PTFE) is expanded polytetrafluoroethylene (ePTFE), for example, an expanded PTFE membrane such as the EMFLON membrane. The symmetric fluoropolymer membrane or asymmetric fluoropolymer membrane of layer (B) can have any suitable pore structure, e.g., a pore size (for example, as evidenced by bubble point, or by KL as described in, for example, U.S. Pat. No. 4,340,479, or evidenced by capillary condensation flow porometry), a mean flow pore (MFP) size (e.g., when characterized using a porometer, for example, a Porvair Porometer (Porvair plc, Norfolk, UK), or a porometer available under the trademark POROLUX (Porometer.com; Belgium)), a pore rating, a pore diameter (e.g., when characterized using the modified OSU F2 test as described in, for example, U.S. Pat. No. 4,925,572), or removal rating media.

The symmetric fluoropolymer membrane or asymmetric fluoropolymer membrane of layer (B) may be prepared by methods known to those skilled in the art. See, e.g., U.S. Pat. Nos. 3,953,566; 4,187,390; and 3,962,153, which describe some methods for preparing porous PTFE membranes. For example, the symmetric fluoropolymer membrane or asymmetric fluoropolymer membrane of layer (B) can be prepared from a paste-forming fluoropolymer such as a fine powder fluoropolymer. A blend or preform comprising a fine powder PTFE resin, e.g., ASTM D 4895 Type I, grade 3, and an extrusion aid (or lubricant) is prepared by techniques known to those skilled in the art, e.g., compression molding. A fine powder PTFE resin may be obtained from Asahi Glass Fluoropolymers, Bayonne, N.J. Examples of extrusion aids include liquid hydrocarbons such as solvent naphtha and white oil, aromatic hydrocarbons, alcohols, ketones, esters, oils, e.g., mineral oil, hydrofluorocarbons, e.g., FREON™ 134a, and water, e.g., water containing a surfactant; and the preform is shaped into an article such as a sheet, e.g., by pressing or rolling.

The resulting sheet may be pressed, rolled, or calendared, e.g., between driven rolls, to a desired thickness, typically to about 2 mils (about 50 μm) or less to about 14 mils (about 350 μm) or more, and the resulting (unsintered) sheet is expanded by stretching it in one, two, three, or more directions. For example, the stretching is carried out monoaxially or biaxially. The stretching produces a microstructure containing nodes and fibrils. The stretched sheet, while in the stretched condition, is heated to amorphous lock the membrane. The heat sinters the membrane. Sintering can be complete, or partial. The amorphous locking process stabilizes the nodes. The amorphous locked membrane is cooled to ambient temperatures. The expansion (stretching) and sintering can also be done simultaneously. See, e.g., U.S. Pat. Nos. 4,761,754; 4,714,748; and 4,760,012. The expanded, sintered membrane may be further expanded at a temperature above the crystalline melting temperature of the highest melting PTFE present and stretched in a direction orthogonal or perpendicular to the direction of the first stretch that took place below the melt temperature of the PTFE. See, e.g., U.S. Pat. No. 5,814,405. The extrusion aid can be removed before, during, or preferably after the stretching.

The symmetric fluoropolymer membrane or asymmetric fluoropolymer membrane of layer (B) preferably has a microstructure characterized by nodes and fibrils. The direction, size, and shape of the nodes may vary, and the thickness, direction, length, orientation of the fibrils may vary, depending upon the method of preparation. For example, if the symmetric fluoropolymer membrane or asymmetric fluoropolymer membrane of layer (B) is produced by uniaxial expansion, the nodes are elongated, the longer axis of the nodes being oriented generally perpendicular to the direction of expansion. The fibrils interconnecting the nodes are generally parallel to the direction of expansion. Biaxial and triaxial expansions can orient the fibrils in two or three directions, and changes can occur in the distribution, size, and shape of the nodes.

The fibrils of the symmetric fluoropolymer membrane or asymmetric fluoropolymer membrane of layer (B), in an embodiment, are generally thin or have a narrow cross-section or diameter. The nodes can vary in size, e.g., diameter, from about 400 μm to about 0.05 μm, depending on the conditions employed in the production, e.g., during expansion. The nodes may include agglomeration of smaller nodes.

Thus, layer (B) can have any suitable mean flow pore size (e.g., when characterized using a porometer, for example, a Porvair Porometer (Porvair plc, Norfolk, UK), or a porometer available under the trademark POROLUX (Porometer.com; Belgium)). For example, layer (B) can have a mean flow pore size of 50 nm or more, for example, 60 nm or more, 70 nm or more, 80 nm or more, 90 nm or more, or 100 nm or more. Alternatively, or additionally, layer (B) can have a mean flow pore size of 1 μm or less, for example, 500 nm or less, 400 nm or less, 300 nm or less, 200 nm or less, or 100 nm or less. Thus, layer (B) can have a mean flow pore size bounded by any two of the aforementioned endpoints. For example, layer (B) can have a mean flow pore size of 50 nm to 1 μm, 50 nm to 500 nm, 50 nm to 400 nm, 50 nm to 300 nm, 50 nm to 200 nm, 50 nm to 100 nm, 60 nm to 1 μm, 60 nm to 500 nm, 60 nm to 400 nm, 60 nm to 300 nm, 60 nm to 200 nm, 60 nm to 100 nm, 70 nm to 1 μm, 70 nm to 500 nm, 70 nm to 400 nm, 70 nm to 300 nm, 70 nm to 200 nm, 70 nm to 100 nm, 80 nm to 1 μm, 80 nm to 500 nm, 80 nm to 400 nm, 80 nm to 300 nm, 80 nm to 200 nm, 80 nm to 100 nm, 90 nm to 1 μm, 90 nm to 500 nm, 90 nm to 400 nm, 90 nm to 300 nm, 90 nm to 200 nm, 90 nm to 100 nm, 100 nm to 1 μm, 100 nm to 500 nm, 100 nm to 400 nm, 100 nm to 300 nm, 100 nm to 200 nm, or 100 nm to 100 nm. In some embodiments, layer (B) has a mean flow pore size of 60 nm to 500 nm or a mean flow pore size of 60 nm to 200 nm. In certain embodiments, layer (B) has a mean flow pore size of 60 nm to 100 nm.

The porous membrane comprises layer (C) comprising a composite fluoropolymer comprising (i) the amorphous fluoropolymer and (ii) the symmetric fluoropolymer membrane or the asymmetric fluoropolymer membrane. As used herein, the term “composite” refers to a mixture of (i) an amorphous fluoropolymer described herein and (ii) a symmetric fluoropolymer membrane or an asymmetric fluoropolymer membrane described herein (e.g., the porous membrane of layer (B)). For example, the composite can be formed from phase inverting a solution (e.g., a casting solution) comprising the amorphous fluoropolymer resin, which has been incorporated into the symmetric fluoropolymer membrane or the asymmetric fluoropolymer membrane by a method described herein.

The porous membrane comprises a layer (A), a layer (B), and a layer (C) with an orientation of A-C-B. For example, the porous membrane can have an orientation of A-C-B, B-C-A-C-B, A-C-B-C-A-C-B, or B-C-A-C-B-C-A-C-B, etc. In some embodiments, the porous membrane comprises a layer (A), a layer (B), and a layer (C) with an orientation of B-C-A-C-B.

The porous membrane can have any suitable thickness. Thus, the porous membrane can have and average thickness of 5 microns or more, for example, 10 microns or more, 25 microns or more, 50 microns or more, or 100 microns or more. Alternatively, or additionally, the porous membrane can have an average thickness of 5000 microns or less, for example, 2000 microns or less, 1000 microns or less, 500 microns or less, 250 microns or less, 200 microns or less, or 100 microns or less. Thus, the porous membrane can have an average thickness bounded by any two of the aforementioned endpoints. For example, the porous membrane can have a an average thickness of 5 microns to 5000 microns, 5 microns to 2000 microns, 5 microns to 1000 microns, 5 microns to 500 microns, 5 microns to 250 microns, 5 microns to 200 microns, 5 microns to 100 microns, 10 microns to 5000 microns, 10 microns to 2000 microns, 10 microns to 1000 microns, 10 microns to 500 microns, 10 microns to 250 microns, 10 microns to 200 microns, 10 microns to 100 microns, 25 microns to 5000 microns, 25 microns to 2000 microns, 25 microns to 1000 microns, 25 microns to 500 microns, 25 microns to 250 microns, 25 microns to 200 microns, 25 microns to 100 microns, 50 microns to 5000 microns, 50 microns to 2000 microns, 50 microns to 1000 microns, 50 microns to 500 microns, 50 microns to 250 microns, 50 microns to 200 microns, 50 microns to 100 microns, 100 microns to 5000 microns, 100 microns to 2000 microns, 100 microns to 1000 microns, 100 microns to 500 microns, 100 microns to 250 microns, or 100 microns to 200 microns. In some embodiments, the porous membrane has an average thickness of 25 microns to 1000 microns. In certain embodiments, the porous membrane has an average thickness of 25 microns to 500 microns. In preferred embodiments, the porous membrane has an average thickness of 25 microns to 250 microns.

The porous membrane can have any suitable mean flow pore size (e.g., when characterized using a porometer, for example, a Porvair Porometer (Porvair plc, Norfolk, UK), or a porometer available under the trademark POROLUX (Porometer.com; Belgium)). For example, the porous membrane can have a mean flow pore size of 5 nm or more, for example, 10 nm or more, 20 nm or more, 30 nm or more, or 40 nm or more. Alternatively, or additionally, the porous membrane can have a mean flow pore size of 80 nm or less, for example, 70 nm or less, 60 nm or less, 50 nm or less, or 40 nm or less. Thus, the porous membrane can have a mean flow pore size bounded by any two of the aforementioned endpoints. For example, the porous membrane can have a mean flow pore size of 5 nm to 80 nm, 5 nm to 70 nm, 5 nm to 60 nm, 5 nm to 50 nm, 5 nm to 40 nm, 10 nm to 80 nm, 10 nm to 70 nm, 10 nm to 60 nm, 10 nm to 50 nm, 10 nm to 40 nm, 20 nm to 80 nm, 20 nm to 70 nm, 20 nm to 60 nm, 20 nm to 50 nm, 20 nm to 40 nm, 30 nm to 80 nm, 30 nm to 70 nm, 30 nm to 60 nm, 30 nm to 50 nm, 30 nm to 40 nm, 40 nm to 80 nm, 40 nm to 70 nm, 40 nm to 60 nm, or 40 nm to 50 nm. In some embodiments, the porous membrane has a mean flow pore size of 10 nm to 60 nm. In certain embodiments, the porous membrane has a mean flow pore size of 20 nm to 60 nm. In preferred embodiments, the porous membrane has a mean flow pore size of 20 nm to 40 nm.

In some embodiments, layer (C) has an average pore size (e.g., when characterized using a scanning electron microscope) that is smaller than an average pore size of layer (B). Without wishing to be bound by any particularly theory, it is believed that by drawing at least a portion of the solution comprising the amorphous fluoropolymer into the symmetric fluoropolymer membrane or the asymmetric fluoropolymer membrane, as described herein, the average pore size of the resulting composite is smaller than the average pore size of the symmetric fluoropolymer membrane or the asymmetric fluoropolymer membrane. Alternatively, or additionally, layer (C) can have an average pore size (e.g., when characterized using a scanning electron microscope) that increases from a side contacting layer (A) to a side contacting layer (B). Without wishing to be bound by any particularly theory, it is believed that by drawing at least a portion of the solution comprising the amorphous fluoropolymer into the symmetric fluoropolymer membrane or the asymmetric fluoropolymer membrane, as described herein, the concentration of the amorphous fluoropolymer in the composite layer (C) decreases from a side contacting layer (A) to a side contacting layer (B), and, thus, the average pore size increases from a side contacting layer (A) to a side contacting layer (B). Alternatively, or additionally, layer (B) can have an average pore size (e.g., when characterized using a scanning electron microscope) that increases from a side contacting layer (C) to the surface of the porous membrane.

In some embodiments, the porous membranes of the present invention have the desirable surface characteristics to undergo little or no fouling and/or allow rapid membrane cleaning. In addition, the porous membranes of the present invention can have solvent resistance, chemical resistance, and heat resistance. In certain embodiments, the porous membrane is free or substantially free of leachables. Accordingly, the purity of a treated fluid using the porous membrane is not compromised.

The invention also provides a method of making a porous membrane (e.g., a porous membrane comprising a layer (A), a layer (B), and a layer (C) described herein).

In some embodiments, the method comprises:
(i) casting a solution comprising an amorphous fluoropolymer resin on a first surface of a symmetric fluoropolymer membrane or an asymmetric fluoropolymer membrane,
(ii) applying a pressure to a second surface of the symmetric fluoropolymer membrane or the asymmetric fluoropolymer membrane, thereby drawing at least a portion of the solution comprising the amorphous fluoropolymer into the symmetric fluoropolymer membrane or the asymmetric fluoropolymer membrane, and
(iii) phase inverting the solution comprising the amorphous fluoropolymer resin to form a porous membrane comprising a layer (A), a layer (B), and a layer (C) with an orientation of A-C-B, wherein
   a. layer (A) comprises an amorphous fluoropolymer,
   b. layer (B) comprises a symmetric fluoropolymer membrane or an asymmetric fluoropolymer membrane, and
   c. layer (C) comprises a composite fluoropolymer comprising (i) the amorphous fluoropolymer and (ii) the symmetric fluoropolymer membrane or the asymmetric fluoropolymer membrane.

In some embodiments, the method comprises:
(i) casting a solution comprising an amorphous fluoropolymer resin on a first surface of a first symmetric fluoropolymer membrane or a first asymmetric fluoropolymer membrane,
(ii) applying a first surface of a second symmetric fluoropolymer membrane or a second asymmetric fluoropolymer membrane onto the cast solution,
(iii) applying a pressure to a second surface of the first symmetric fluoropolymer membrane or the first asymmetric fluoropolymer membrane and/or a second surface of the second symmetric fluoropolymer membrane or the second asymmetric fluoropolymer membrane, thereby drawing at least a portion of the solution comprising the amorphous fluoropolymer into the first symmetric fluoropolymer membrane or the first asymmetric fluoropolymer membrane and/or the second symmetric fluoropolymer membrane or the second asymmetric fluoropolymer membrane, and
(iv) phase inverting the solution comprising the amorphous fluoropolymer resin to form a porous membrane comprising a layer (A), a layer (B), and a layer (C) with an orientation of B-C-A-C-B, wherein
   a. layer (A) comprises an amorphous fluoropolymer,
   b. layer (B) comprises a symmetric fluoropolymer membrane or an asymmetric fluoropolymer membrane, and
   c. layer (C) comprises a composite fluoropolymer comprising (i) the amorphous fluoropolymer and (ii) the symmetric fluoropolymer membrane or the asymmetric fluoropolymer membrane.

The methods comprise casting a solution comprising an amorphous fluoropolymer resin on a surface of a symmetric fluoropolymer membrane or an asymmetric fluoropolymer membrane. In some embodiments, the solution comprising an amorphous fluoropolymer further comprises one or more solvents and/or non-solvents. Exemplary solvents/non-solvents include, but are not limited to, halogenated solvents such as fluorocarbons (e.g., perfluorocarbons) or solvents from the 3M™ NOVEC™ series (e.g., 3M™ NOVEC™ 7500), GENESOL V™ 2000 (1,1-dichloro-1-fluoroethane) from AlliedSignal, Inc., FC-43 (perfluoro C₁₂ alkane) from 3M™ ECTFE™ oil (ethylene-chlorotrifluoroethylene copolymer) from Halocarbon Co. (River Edge, N.J.), CHEMOURS™ OPTEON™ series, SOLVAY™ SOLKANE™ series, acetone, ethanol, isopropanol, diethyl ether, ethyl acetate, tetrahydrofuran, and a combination thereof. In certain embodiments, the solution comprising the amorphous fluoropolymer resin comprises a halogenated solvent, acetone, ethanol, isopropanol, diethyl ether, ethyl acetate, tetrahydrofuran, or a combination thereof.

The methods of making a porous membrane comprise applying a pressure to a surface of the symmetric fluoropolymer membrane or the asymmetric fluoropolymer membrane, thereby drawing at least a portion of the solution comprising the amorphous fluoropolymer into the symmetric fluoropolymer membrane or the asymmetric fluoropolymer membrane. The pressure can be applied by any suitable means so long as at least a portion of the solution comprising the amorphous fluoropolymer is drawn into the symmetric fluoropolymer membrane or the asymmetric fluoropolymer membrane. In some embodiments, the pressure is applied by vacuum, a Mayer bar, a slot die, a doctor blade, an air blade, or a combination thereof.

The methods of making a porous membrane comprise phase inverting the solution comprising the amorphous fluoropolymer resin to form a porous membrane comprising a layer (A), a layer (B), and a layer (C). The phase inversion can be performed by any suitable method. For example, the phase inversion can be performed by precipitation from vapor phase, precipitation by controlled evaporation, thermally induced phase separation, or immersion precipitation.

All other aspects of the method of making a porous membrane (e.g., a porous membrane comprising a layer (A), a layer (B), and a layer (C) described herein), e.g., the amorphous fluoropolymer, the symmetric fluoropolymer membrane, the asymmetric fluoropolymer membrane, and the composite fluoropolymer are as described herein with respect to the porous membrane.

The invention further provides a method of treating a contaminated fluid comprising passing at least a portion of the contaminated fluid through a porous membrane described herein and a method of recovering a material from a fluid comprising passing at least a portion of the fluid through a porous membrane described herein, so as to retain at least a portion of the material on the porous membrane.

In some embodiments, the fluid (e.g., the contaminated fluid) is corrosive, and optionally has an elevated temperature (e.g., a temperature of 50° C. or more, 100° C. or more, or 150° C. or more). For example, the fluid can comprise a strong acid (e.g., sulfuric acid or hydrofluoric acid), a strong base (e.g., sodium hydroxide or potassium hydroxide), or a strong oxidant (e.g., peroxides such as hydrogen peroxide). Exemplary fluids that may be corrosive include, but are not limited to, etching fluids used in the electronics industry or other lithography-based processes. In that respect, the etching fluid may be passed through a porous membrane described herein to remove or isolate a contaminant such as, for example, a metal, a polymer, a ceramic particle, or other etching particulates.

In some embodiments, the fluid (e.g., the contaminated fluid) is a biological composition. For example, the biological composition may be passed through a porous membrane described herein to remove or isolate biological material such as, for example, a biopolymer (e.g., a glycopolymer, a cellulosic polymer, etc.), a lipid (e.g., lipid vesicles, micelles, liposomes, etc.), a carbohydrate (e.g., sugar, starch, cellulose, glycogen, etc.), a peptide (e.g., a polypeptide, a protein, a peptide mimetic, a glycopeptide, etc.), an antibody construct (e.g., antibody, an antibody-derivative (including Fc fusions, Fab fragments and scFvs), etc.), a nucleotide (e.g., RNA, DNA, antisense, siRNA, an aptamer, etc.), a bacteria, a virus, or any combination thereof. In some embodiments, the biomaterial comprises lentivirus, AAV capsid, or plasmid DNA, and other biological contaminants from the fluid.

### ASPECTS OF THE DISCLOSURE

Aspects, including embodiments, of the invention described herein may be beneficial alone or in combination, with one or more other aspects or embodiments. Without limiting the foregoing description, certain non-limiting aspects of the disclosure numbered 1-24 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:

(1) In aspect (1) is presented a porous membrane comprising a layer (A), a layer (B), and a layer (C) with an orientation of A-C-B, wherein
layer (A) comprises an amorphous fluoropolymer,
layer (B) comprises a symmetric fluoropolymer membrane or an asymmetric fluoropolymer membrane, and
layer (C) comprises a composite fluoropolymer comprising (i) the amorphous fluoropolymer and (ii) the symmetric fluoropolymer membrane or the asymmetric fluoropolymer membrane.

(2) In aspect (2) is presented a porous membrane comprising a layer (A), a layer (B), and a layer (C) with an orientation of B-C-A-C-B, wherein
each layer (A) comprises an amorphous fluoropolymer,
each layer (B) comprises a symmetric fluoropolymer membrane or an asymmetric fluoropolymer membrane, and
each layer (C) comprises a composite fluoropolymer comprising (i) the amorphous fluoropolymer and (ii) the symmetric fluoropolymer membrane or the asymmetric fluoropolymer membrane.

(3) In aspect (3) is presented the porous membrane of aspect (1) or aspect (2), wherein layer (C) has an average pore size that is smaller than an average pore size of layer (B).

(4) In aspect (4) is presented the porous membrane of any one of aspects (1)-(3), wherein layer (C) has an average pore size that increases from a side contacting layer (A) to a side contacting layer (B).

(5) In aspect (5) is presented the porous membrane of any one of aspects (1)-(4), wherein the amorphous fluoropolymer comprises an ether group, a dioxole group, or a combination thereof.

(6) In aspect (6) is presented the porous membrane of any one of aspects (1)-(5), wherein the amorphous fluoropolymer comprises at least one tetrafluoroethylene unit and at least one fluorinated ether unit, fluorinated dioxole unit, or a combination thereof.

(7) In aspect (7) is presented the porous membrane of any one of aspects (1)-(6), wherein the symmetric fluoropolymer membrane or the asymmetric polymer membrane comprises polytetrafluoroethylene (PTFE).

(8) In aspect (8) is presented the porous membrane of aspect (7), wherein the polytetrafluoroethylene (PTFE) is expanded polytetrafluoroethylene (ePTFE).

(9) In aspect (9) is presented the porous membrane of any one of aspects (1)-(8), wherein layer (B) has a mean flow pore size of 60 nm to 500 nm.

(10) In aspect (10) is presented the porous membrane of any one of aspects (1)-(8), wherein layer (B) has a mean flow pore size of 60 nm to 200 nm.

(11) In aspect (11) is presented the porous membrane of any one of aspects (1)-(8), wherein layer (B) has a mean flow pore size of 60 nm to 100 nm.

(12) In aspect (12) is presented the porous membrane of any one of aspects (1)-(11), wherein the porous membrane has a mean flow pore size of 10 nm to 60 nm.

(13) In aspect (13) is presented the porous membrane of any one of aspects (1)-(11), wherein the porous membrane has a mean flow pore size of 20 nm to 60 nm.

(14) In aspect (14) is presented the porous membrane of any one of aspects (1)-(11), wherein the porous membrane has a mean flow pore size of 20 nm to 40 nm.

(15) In aspect (15) is presented the porous membrane of any one of aspects (1)-(14), wherein the porous membrane has an average thickness of 5 microns to 1000 microns.

(16) In aspect (16) is presented the porous membrane of any one of aspects (1)-(14), wherein the porous membrane has an average thickness of 25 microns to 500 microns.

(17) In aspect (17) is presented the porous membrane of any one of aspects (1)-(14), wherein the porous membrane has an average thickness of 25 microns to 250 microns.

(18) In aspect (18) is presented a method of making a porous membrane, the method comprising:
(i) casting a solution comprising an amorphous fluoropolymer resin on a first surface of a symmetric fluoropolymer membrane or an asymmetric fluoropolymer membrane,
(ii) applying a pressure to a second surface of the symmetric fluoropolymer membrane or the asymmetric fluoropolymer membrane, thereby drawing at least a portion of the solution comprising the amorphous fluoropolymer into the symmetric fluoropolymer membrane or the asymmetric fluoropolymer membrane, and
(iii) phase inverting the solution comprising the amorphous fluoropolymer resin to form a porous membrane comprising a layer (A), a layer (B), and a layer (C) with an orientation of A-C-B, wherein
   a. layer (A) comprises an amorphous fluoropolymer,
   b. layer (B) comprises a symmetric fluoropolymer membrane or an asymmetric fluoropolymer membrane, and
   c. layer (C) comprises a composite fluoropolymer comprising (i) the amorphous fluoropolymer and (ii) the symmetric fluoropolymer membrane or the asymmetric fluoropolymer membrane.

(19) In aspect (19) is presented a method of making a porous membrane, the method comprising:
(i) casting a solution comprising an amorphous fluoropolymer resin on a first surface of a first symmetric fluoropolymer membrane or a first asymmetric fluoropolymer membrane,
(ii) applying a first surface of a second symmetric fluoropolymer membrane or a second asymmetric fluoropolymer membrane onto the cast solution,
(iii) applying a pressure to a second surface of the first symmetric fluoropolymer membrane or the first asymmetric fluoropolymer membrane and/or a second surface of the second symmetric fluoropolymer membrane or the second asymmetric fluoropolymer membrane, thereby drawing at least a portion of the solution comprising the amorphous fluoropolymer into the first symmetric fluoropolymer membrane or the first asymmetric fluoropolymer membrane and/or the second symmetric fluoropolymer membrane or the second asymmetric fluoropolymer membrane, and
(iv) phase inverting the solution comprising the amorphous fluoropolymer resin to form a porous membrane comprising a layer (A), a layer (B), and a layer (C) with an orientation of B-C-A-C-B, wherein
   a. layer (A) comprises an amorphous fluoropolymer,
   b. layer (B) comprises a symmetric fluoropolymer membrane or an asymmetric fluoropolymer membrane, and
   c. layer (C) comprises a composite fluoropolymer comprising (i) the amorphous fluoropolymer and (ii) the symmetric fluoropolymer membrane or the asymmetric fluoropolymer membrane.

(20) In aspect (20) is presented the method of aspect (18) or aspect (19), wherein the pressure is applied by vacuum, a Mayer bar, a slot die, a doctor blade, an air blade, or a combination thereof.

(21) In aspect (21) is presented the method of any one of aspects (18)-(20), wherein the solution comprising the amorphous fluoropolymer resin comprises a halogenated solvent, acetone, ethanol, isopropanol, diethyl ether, ethyl acetate, tetrahydrofuran, or a combination thereof.

(22) In aspect (22) is presented a method of treating a contaminated fluid comprising passing at least a portion of the contaminated fluid through the porous membrane of any one of aspects (1)-(17).

(23) In aspect (23) is presented the method of aspect (22), wherein the contaminated fluid is corrosive.

(24) In aspect (24) is presented a method of recovering a material from a fluid comprising passing at least a portion of the fluid through the porous membrane of any one of aspects (1)-(17), so as to retain at least a portion of the material on the porous membrane.

### EXAMPLES

These following examples further illustrate the invention but, of course, should not be construed as in any way limiting its scope.

### Example 1

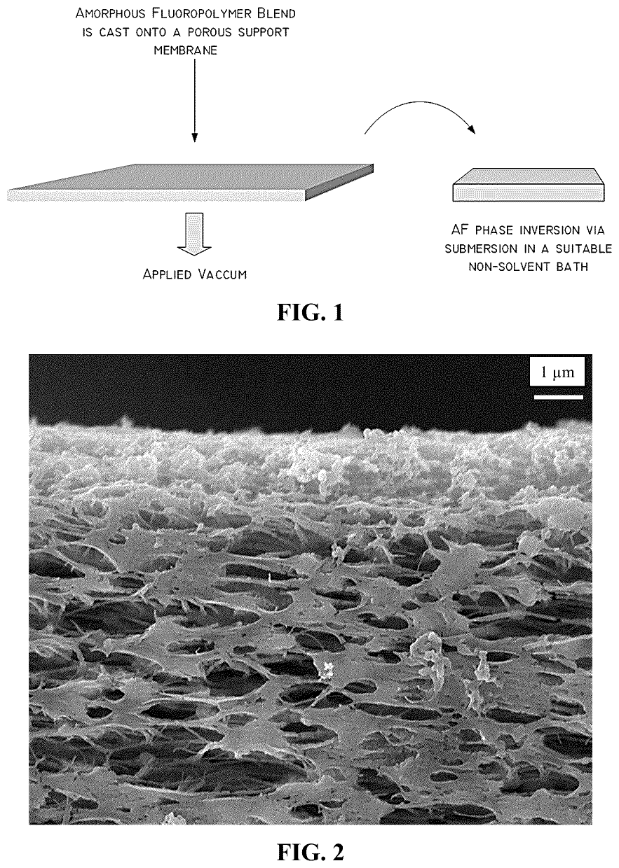

This example illustrates the preparation of a porous membrane comprising an amorphous fluoropolymer, a composite, and an asymmetric fluoropolymer membrane, described herein, by applying pressure via a vacuum as depicted in FIG. 1.

A polymer blend containing CHEMOURS™ TEFLON™ AF1600 fluoropolymer (0.4 grams) and 3M™ NOVEC™ 7500 fluorocarbon solvent (9.6 grams) was prepared and incubated for 24 hours at 60° C. and allowed to equilibrate at 20° C.

A strip (3″ wide×8″ long) of asymmetric expanded polytetrafluoroethylene (ePTFE) membrane (0.2 micron, commercially available from Sumitomo®) was placed on a flat-bed casting machine with a linear speed of 40 mm/sec. A stainless-steel Mayer bar (4-mil rating) was placed on top of the ePTFE membrane support at its front edge. Three grams of the amorphous fluoropolymer blend was poured across the ePTFE support, just downstream of the Mayer bar, and the casting was initiated. Once the Mayer bar completely traversed the ePTFE support, the amorphous fluoropolymer blend/ePTFE construct was removed and placed upon a glass frit (2″ diameter) fitted atop an Erlenmeyer filtering flask connected to a vacuum source (700 mm Hg). Vacuum was applied for 5 seconds after which the construct was removed and placed in an acetone bath for phase inversion at 20° C. for 2 minutes. The newly formed membrane was subsequently removed and immersed in an isopropyl alcohol bath at 20° C. for 2 minutes, followed by removal and drying in air under ambient conditions.

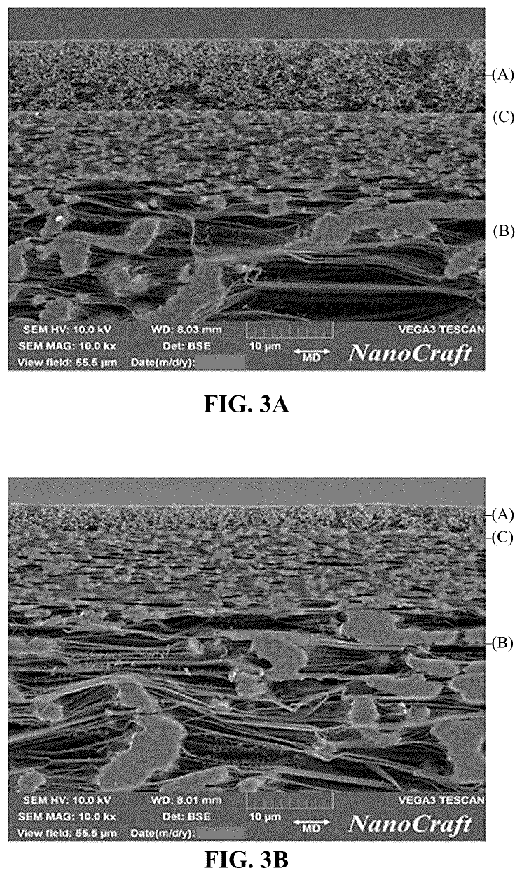

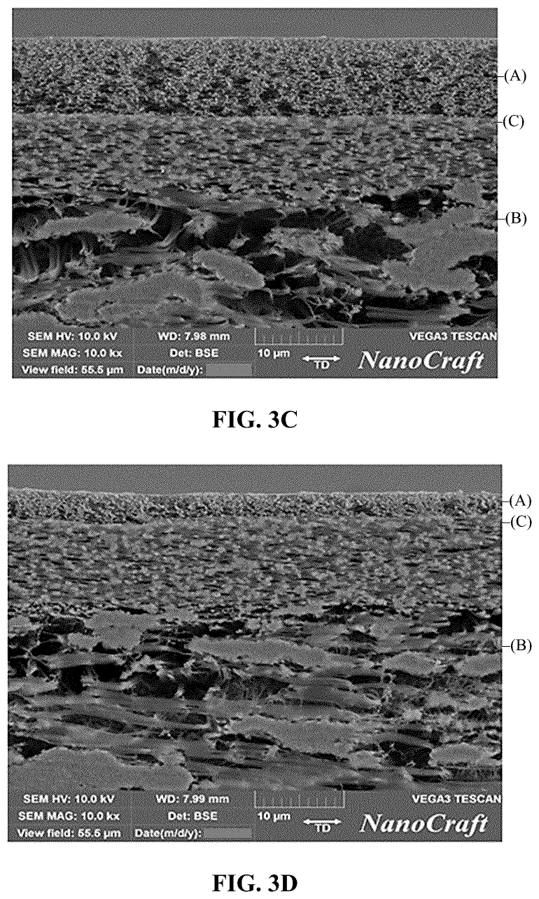

Scanning electron microscope (SEM) images of the resulting porous membrane were taken and are provided in FIGS. 2 and 3A-3D. As is apparent from the results set forth in FIGS. 3A-3D, three distinguishable layers are present, which include from top to bottom, an amorphous fluoropolymer layer (A), a composite layer (C), and an asymmetric fluoropolymer membrane layer (B).

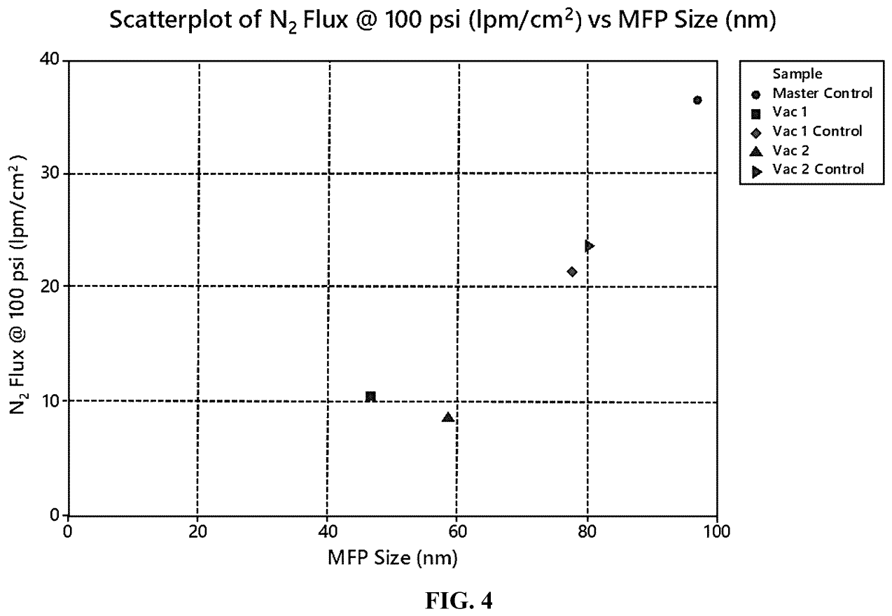

To demonstrate that the porous membrane, prepared by this example, had a reduced mean pore size relative to a porous membrane prepared without applying a vacuum, the mean flow pore (MFP) size was measured. An independent control membrane produced immediately prior to the vacuum experiments (Master Control), two controls taken outside of the membrane area that was exposed to the vacuum (Vac 1 Control and Vac 2 Control), and test membranes from two different areas exposed to the vacuum (Vac1 and Vac 2) were subjected to nitrogen flux at 100 psi (689.5 kPa). The results are set forth in FIG. 4.

As is apparent from the results set forth in FIG. 4, the test membranes had a MFP size of approximately 40-60 nm at about 10 N₂ flux @ 100 psi (lpm/cm²), whereas the two controls, which were not subjected to vacuum, had a MFP size of approximately 80 nm at about 20 N₂ flux @ 100 psi (lpm/cm²). Similarly, the master control had a MFP size of approximately 100 nm at about 35 N₂ flux @ 100 psi (lpm/cm²). These results show that applying pressure via a vacuum reduced the mean flow pore size of the porous membrane by approximately 25-50%.

### Example 2

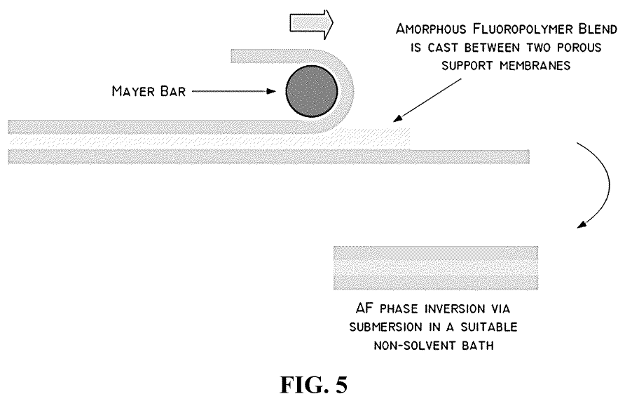

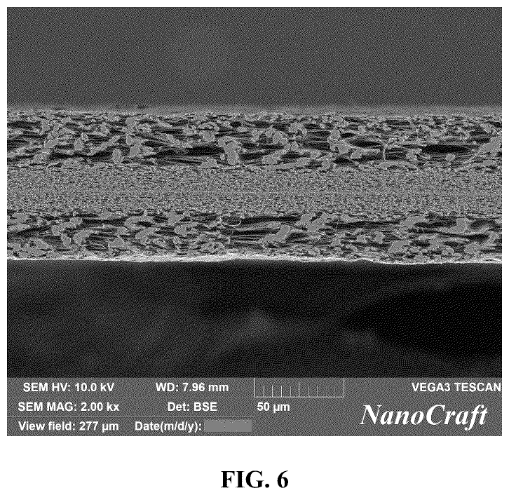

This example illustrates the preparation of a porous membrane comprising an amorphous fluoropolymer, a composite, and an asymmetric fluoropolymer membrane, described herein, by applying pressure via a Mayer bar as depicted in FIG. 5.

A polymer blend containing CHEMOURS™ TEFLON™ AF2400 fluoropolymer (0.15 grams) and 3M™ NOVEC™ 7500 fluorocarbon solvent (9.85 grams) was prepared and incubated for 24 hours at 60° C. and allowed to equilibrate at 20° C.

Two strips (3″ wide×8″ long) of asymmetric expanded polytetrafluoroethylene (ePTFE) membrane (0.2 micron, commercially available from Sumitomo®) were place atop one another on a flat-bed casting machine with a linear speed of 40 mm/sec. A stainless-steel Mayer bar (4-mil rating) was placed on top of the two ePTFE membrane layers at their leading front edges. The far end of the upper (top) layer of the ePTFE membrane was peeled from the bottom layer back to the location of the Mayer bar, thereby exposing an interface between the upper and lower ePTFE. Three grams of the amorphous fluoropolymer blend was poured across the exposed bottom ePTFE layer, just downstream of the Mayer bar, and the casting was initiated. Once the Mayer bar completely traversed the ePTFE support, thereby compressing the upper ePTFE layer onto the lower ePTFE layer, the amorphous fluoropolymer blend/ePTFE construct was removed and placed in an acetone bath for phase inversion at 20° C. for 2 minutes. The newly formed membrane was subsequently removed and immersed in an isopropyl alcohol bath at 20° C. for 2 minutes, followed by removal and drying in air at ambient conditions.

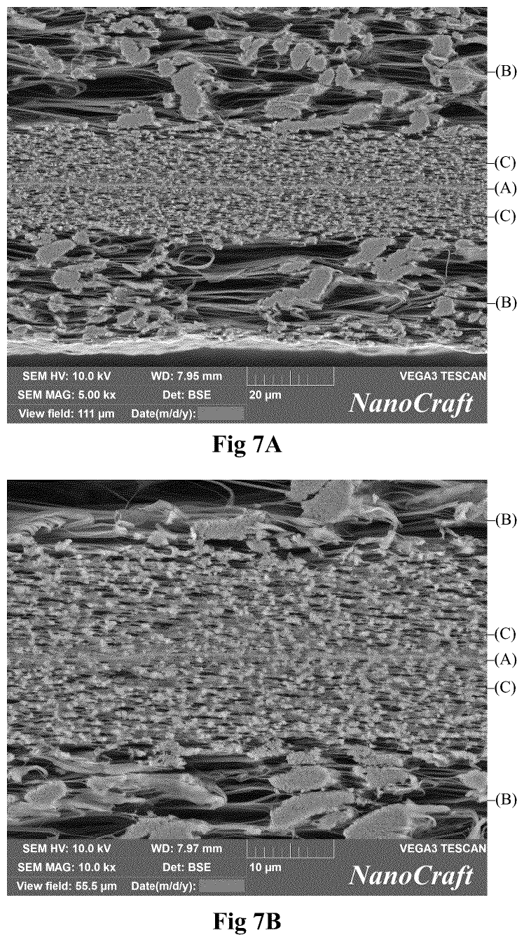

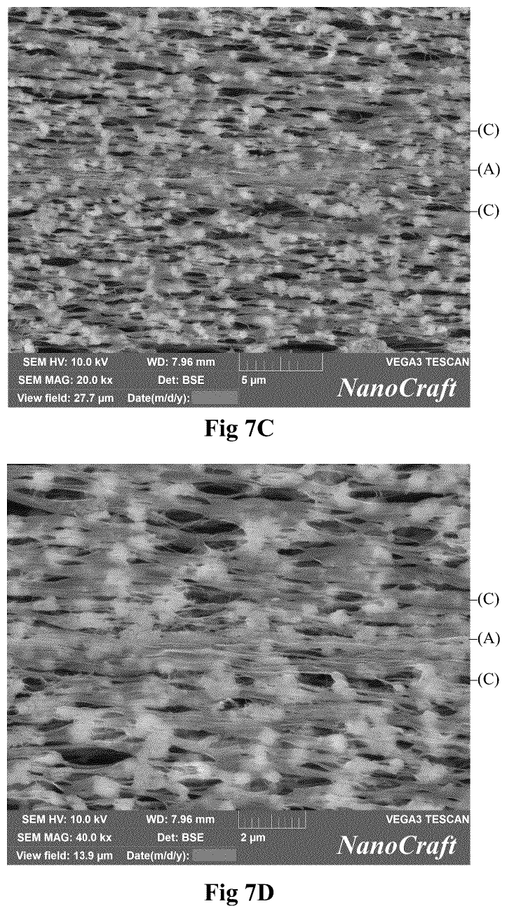

Scanning electron microscope (SEM) images of the resulting porous membrane were taken and are provided in FIGS. 6 and 7A-7D. As is apparent from the results set forth in FIGS. 7A-7D, five distinguishable layers are present, which include from top to bottom, an asymmetric fluoropolymer membrane layer (B), a composite layer (C), an amorphous fluoropolymer layer (A), a composite layer (C), and an asymmetric fluoropolymer membrane layer (B).

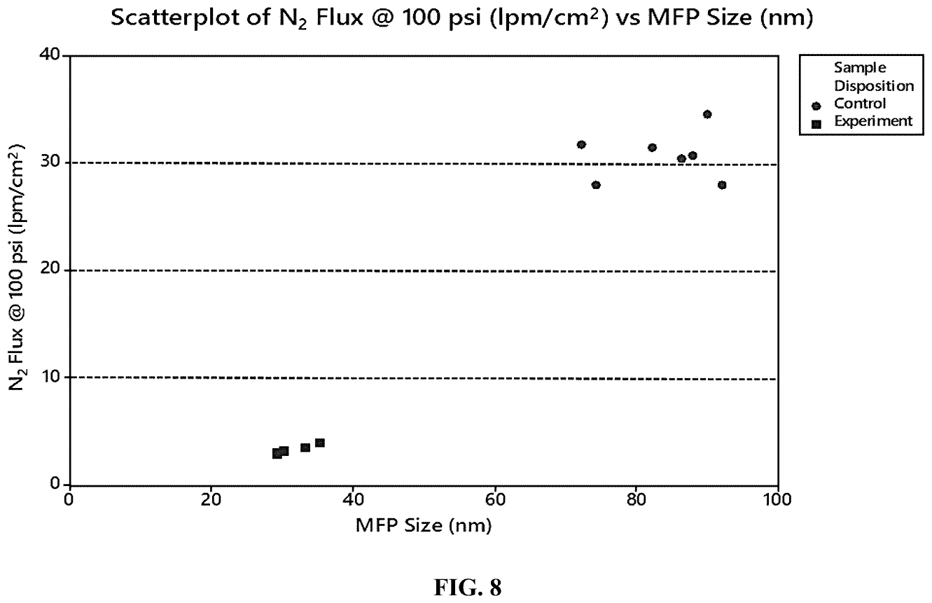

To demonstrate that the porous membrane, prepared by this example, had a reduced mean pore size relative to a porous membrane prepared without compression via an upper PTFE layer, the mean flow pore (MFP) size was measured. Sample disposition control membranes comprising a single amorphous fluoropolymer layer cast onto the asymmetric ePTFE support at identical conditions but without further downstream influence (i.e., without compression via an upper PTFE layer) and test membranes were subjected to nitrogen flux at 100 psi (689.5 kPa). The results are set forth in FIG. 8.

As is apparent from the results set forth in FIG. 8, the test membranes had a MFP size of approximately 30 nm at about 5 N₂ flux @ 100 psi (lpm/cm²), whereas the disposition control membranes had a MFP size of approximately 80 nm at about 30 N₂ flux @ 100 psi (lpm/cm²). These results show that applying pressure via a Mayer bar and an upper ePTFE layer reduced the mean flow pore size of the porous membrane by approximately 60% relative to the control membranes.

### Example 3

This example illustrates the preparation of a porous membrane comprising an amorphous fluoropolymer, a composite, and a symmetric fluoropolymer membrane, described herein, by applying pressure via a Mayer bar as depicted in FIG. 5.

A polymer blend containing CHEMOURSIM TEFLON™ AF2400 fluoropolymer (0.15 grams) and 3M™ NOVEC™ 7500 fluorocarbon solvent (9.85 grams) was prepared and incubated for 24 hours at 60° C. and allowed to equilibrate at 20° C.

Two strips (3″ wide×8″ long) of symmetric expanded polytetrafluoroethylene (ePTFE) membrane (0.45 micron, commercially available from Sumitomo®) were place atop one another on a flat-bed casting machine with a linear speed of 40 mm/sec. A stainless-steel Mayer bar (4-mil rating) was placed on top of the two ePTFE membrane layers at their leading front edges. The far end of the upper (top) layer of the ePTFE membrane was peeled from the bottom layer back to the location of the Mayer bar, thereby exposing an interface between the upper and lower ePTFE. Three grams of the amorphous fluoropolymer blend was poured across the exposed bottom ePTFE layer, just downstream of the Mayer bar, and the casting was initiated. Once the Mayer bar completely traversed the ePTFE support, thereby compressing the upper ePTFE layer onto the lower ePTFE layer, the amorphous fluoropolymer blend/ePTFE construct was removed and placed in an acetone bath for phase inversion at 20° C. for 2 minutes. The newly formed membrane was subsequently removed and immersed in an isopropyl alcohol bath at 20° C. for 2 minutes, followed by removal and drying in air at ambient conditions.

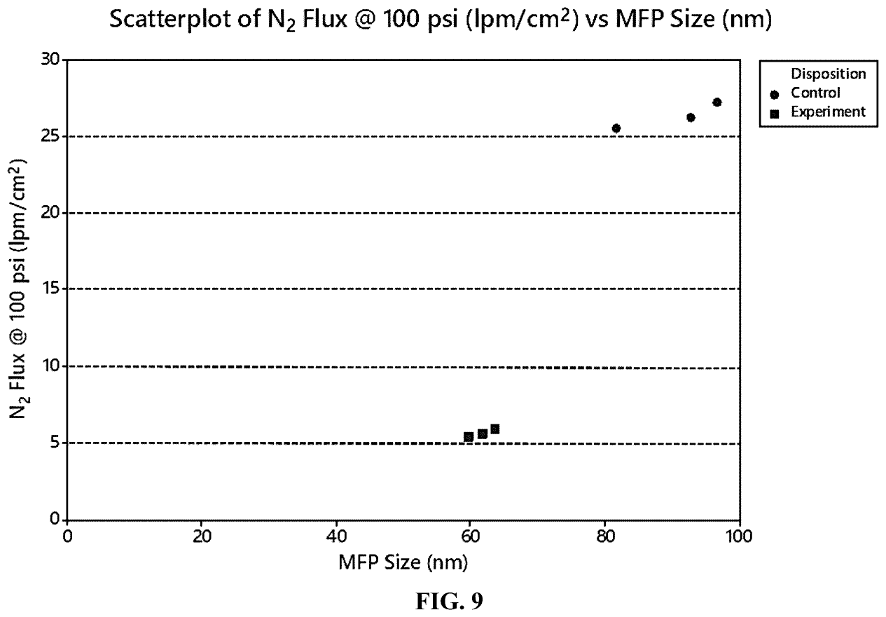

To demonstrate that the porous membrane, prepared by this example, had a reduced mean pore size relative to a porous membrane prepared without compression via an upper PTFE layer, the mean flow pore (MFP) size was measured. Sample disposition control membranes comprising a single amorphous fluoropolymer layer cast onto the symmetric ePTFE support at identical conditions but without further downstream influence (i.e., without compression via an upper PTFE layer) and test membranes were subjected to nitrogen flux at (689.5 kPa). The results are set forth in FIG. 9.

As is apparent from the results set forth in FIG. 9, the test membranes had a MFP size of approximately 60 nm at about 5 N₂ flux @ 100 psi (lpm/cm²), whereas the disposition control membranes had a MFP size of approximately 80-100 nm at about 25-30 N₂ flux @ 100 psi (lpm/cm²). These results show that applying pressure via a Mayer bar and an upper ePTFE layer reduced the mean flow pore size of the porous membrane by approximately 30% relative to the control membranes.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A porous membrane comprising a layer (A), a layer (B), and a layer (C) with an orientation of A-C-B, wherein
layer (A) comprises an amorphous fluoropolymer,
layer (B) comprises a symmetric fluoropolymer membrane or an asymmetric fluoropolymer membrane, and
layer (C) comprises a composite fluoropolymer comprising (i) the amorphous fluoropolymer and (ii) the symmetric fluoropolymer membrane or the asymmetric fluoropolymer membrane.

2. The porous membrane of claim 1, wherein the porous membrane comprises the layer (A), the layer (B), and the layer (C) with an orientation of B-C-A-C-B.

3. The porous membrane of claim 1, wherein layer (C) has an average pore size that is smaller than an average pore size of layer (B).

4. The porous membrane of claim 1, wherein layer (C) has an average pore size that increases from a side contacting layer (A) to a side contacting layer (B).

5. The porous membrane of claim 1, wherein the amorphous fluoropolymer comprises an ether group, a dioxole group, or a combination thereof.

6. The porous membrane of claim 1, wherein the amorphous fluoropolymer comprises at least one tetrafluoroethylene unit and at least one fluorinated ether unit, fluorinated dioxole unit, or a combination thereof.

7. The porous membrane of claim 1, wherein the symmetric fluoropolymer membrane or the asymmetric polymer membrane comprises polytetrafluoroethylene (PTFE).

8. The porous membrane of claim 7, wherein the polytetrafluoroethylene (PTFE) is expanded polytetrafluoroethylene (ePTFE).

9. The porous membrane of claim 1, wherein layer (B) has a mean flow pore size of 60 nm to 500 nm.

10. The porous membrane of any claim 1, wherein layer (B) has a mean flow pore size of 60 nm to 200 nm.

11. The porous membrane of claim 1, wherein the porous membrane has a mean flow pore size of 10 nm to 60 nm.

12. The porous membrane of claim 1, wherein the porous membrane has a mean flow pore size of 20 nm to 60 nm.

13. The porous membrane of claim 1, wherein the porous membrane has an average thickness of 5 microns to 1000 microns.

14. The porous membrane of claim 1, wherein the porous membrane has an average thickness of 25 microns to 500 microns.

15. A method of making a porous membrane, the method comprising:
(i) casting a solution comprising an amorphous fluoropolymer resin on a first surface of a symmetric fluoropolymer membrane or an asymmetric fluoropolymer membrane,
(ii) applying a pressure to a second surface of the symmetric fluoropolymer membrane or the asymmetric fluoropolymer membrane, thereby drawing at least a portion of the solution comprising the amorphous fluoropolymer into the symmetric fluoropolymer membrane or the asymmetric fluoropolymer membrane, and
(iii) phase inverting the solution comprising the amorphous fluoropolymer resin to form a porous membrane comprising a layer (A), a layer (B), and a layer (C) with an orientation of A-C-B, wherein
a. layer (A) comprises an amorphous fluoropolymer,
b. layer (B) comprises a symmetric fluoropolymer membrane or an asymmetric fluoropolymer membrane, and
c. layer (C) comprises a composite fluoropolymer comprising (i) the amorphous fluoropolymer and (ii) the symmetric fluoropolymer membrane or the asymmetric fluoropolymer membrane.

16. A method of making a porous membrane, the method comprising:
(i) casting a solution comprising an amorphous fluoropolymer resin on a first surface of a first symmetric fluoropolymer membrane or a first asymmetric fluoropolymer membrane,
(ii) applying a first surface of a second symmetric fluoropolymer membrane or a second asymmetric fluoropolymer membrane onto the cast solution,
(iii) applying a pressure to a second surface of the first symmetric fluoropolymer membrane or the first asymmetric fluoropolymer membrane and/or a second surface of the second symmetric fluoropolymer membrane or the second asymmetric fluoropolymer membrane, thereby drawing at least a portion of the solution comprising the amorphous fluoropolymer into the first symmetric fluoropolymer membrane or the first asymmetric fluoropolymer membrane and/or the second symmetric fluoropolymer membrane or the second asymmetric fluoropolymer membrane, and
(iv) phase inverting the solution comprising the amorphous fluoropolymer resin to form a porous membrane comprising a layer (A), a layer (B), and a layer (C) with an orientation of B-C-A-C-B, wherein
a. layer (A) comprises an amorphous fluoropolymer,
b. layer (B) comprises a symmetric fluoropolymer membrane or an asymmetric fluoropolymer membrane, and
c. layer (C) comprises a composite fluoropolymer comprising (i) the amorphous fluoropolymer and (ii) the symmetric fluoropolymer membrane or the asymmetric fluoropolymer membrane.

17. The method of claim 15, wherein the pressure is applied by vacuum, a Mayer bar, a slot die, a doctor blade, an air blade, or a combination thereof.

18. The method of claim 16, wherein the pressure is applied by vacuum, a Mayer bar, a slot die, a doctor blade, an air blade, or a combination thereof.

19. A method of treating a contaminated fluid comprising passing at least a portion of the contaminated fluid through the porous membrane of claim 1.

20. A method of recovering a material from a fluid comprising passing at least a portion of the fluid through the porous membrane of claim 1, so as to retain at least a portion of the material on the porous membrane.
